(19) United States
(12) Patent Application Publication
(10) Pub. No.: US 2019/0259342 A1
(43) Pub. Date: Aug. 22, 2019

(54) DISPLAY APPARATUS AND CONTROL METHOD THEREOF

(71) Applicant: CANON KABUSHIKI KAISHA, Tokyo (JP)

(72) Inventors: Mitsuru Tada, Machida-shi (JP); Takehito Fukushima, Fuchu-shi (JP); Takeshi Ikeda, Ebina-shi (JP)

(21) Appl. No.: 16/271,989

(22) Filed: Feb. 11, 2019

(30) Foreign Application Priority Data
Feb. 16, 2018 (JP) 2018-026138

(51) Int. Cl. G09G 3/34; G09G 3/36

(52) U.S. Cl. CPC G09G 3/3406; G09G 3/36; G09G 2320/0626; G09G 2300/023; G09G 2360/144

(57) ABSTRACT

A display apparatus according to the present invention includes: a light-emitting member; a first transmissive panel configured to transmit a light emitted from the light-emitting member, based on first image data of which spatial high frequency components are less than spatial high frequency components of second image data; a second transmissive panel configured to display an image on a display surface by transmitting a light, which is emitted from the light-emitting member and transmitted through the first transmissive panel, based on the second image data; and a detector configured to detect brightness of external light, wherein in a case where the brightness of the external light is high, the spatial high frequency components of the first image data are less than the spatial high frequency components of the first image data in a case where the brightness of the external light is low.

### BACKGROUND OF THE INVENTION

### Field of the Invention

The present invention relates to a display apparatus having a light-emitting unit and two transmissive panels, and a control method thereof.

### Description of the Related Art

In recent years, as a technique to implement high contrast display in a liquid crystal display apparatus, a dual liquid crystal technique, in which two liquid crystal panels are layered and used, is beginning to see practical usage. Each liquid crystal panel has a structure in which two glass plates sandwich a liquid crystal layer, hence a space is generated between the two liquid crystal layers which corresponds to the two liquid crystal panels respectively. Therefore, if each liquid crystal panel (each liquid crystal layer) is set to the same transmittance, an image displayed on the liquid crystal panel on the rear side is not superimposed on an image displayed on the front side of the liquid crystal panel when the display surface is viewed diagonally, which results in the generation of double images.

An available technique to reduce the double images is suppressing spatial high frequency components in an image that are displayed on the rear face side liquid crystal panel (spatial low-pass processing) (WO 2007/040127). However, even if the spatial low-pass processing is performed, display interference, such as halo interference and edge interference, is generated. The halo interference is a display interference in which the area around a light portion (high gradation portion) is brightly blurred, and the edge interference is a display interference in which a shadow that does not exist in the original image data is generated at the boundary between a light portion and a dark portion (low gradation portion).

In the case of viewing a display surface in an environment where external light is strong (bright), the dark portion is difficult to see because the external light reflection brightness (brightness of reflected light generated when external light reflects on the display surface) is high. The halo interference is reduced by the high external light reflection brightness, but the edge interference, which is generated in the light portion, remains when the display surface is viewed diagonally.

Prior arts of the dual liquid crystal technique are also disclosed in Japanese Patent Application Publication No. 2017-26992 and Japanese Patent Application Publication No. 2007-286413. In the case of the technique disclosed in Japanese Patent Application Publication No. 2017-26992, a display mode is switched between a wide viewing angle mode and a narrow viewing angle mode in accordance with the content of the input image (e.g. text, graphic pattern, natural image). In the narrow viewing angle mode alone, the spatial high frequency components of an image that is displayed on the rear side liquid crystal panel are suppressed. In the case of the technique disclosed in Japanese Patent Application Publication No. 2007-286413, the degree of suppression of the spatial high frequency components is determined depending on the pixel pitch of the liquid crystal panel, the distance between the two liquid crystal layers and the like.

### SUMMARY OF THE INVENTION

However, even if the prior arts (e.g. WO 2007/040127, Japanese Patent Application Publication No. 2017-26992 and Japanese Patent Application Publication No. 2007-286413) are used, the edge interference may be generated when the brightness (intensity) of the external light is high. For example, in the case of the technique disclosed in WO 2007/040127, the edge interference is generated if the spatial low-pass processing is performed when the brightness of the external light is high. In the case of the technique disclosed in Japanese Patent Application Publication No. 2017-26992, the edge interference is generated when the brightness of the external light is high because the narrow viewing angle mode is set in accordance with the content of the input image. In the case of the technique disclosed in Japanese Patent Application Publication No. 2007-286413, the edge interference is generated when the brightness of the external light is high because the high degree of suppression is determined in accordance with the pixel pitch of the liquid crystal panel, the distance between the two liquid crystal layers and the like.

The present invention provides a display apparatus which can display an image in which various display interferences (e.g. halo interference, edge interference) are minimized when the brightness of the external light is high.

The present invention in its first aspect provides a display apparatus comprising:

a light-emitting member;

a first transmissive panel configured to transmit a light emitted from the light-emitting member, based on first image data of which spatial high frequency components are less than spatial high frequency components of second image data;

a second transmissive panel configured to display an image on a display surface by transmitting a light, which is emitted from the light-emitting member and transmitted through the first transmissive panel, based on the second image data; and

a detector configured to detect brightness of external light, wherein

in a case where the brightness of the external light is high, the spatial high frequency components of the first image data are less than the spatial high frequency components of the first image data in a case where the brightness of the external light is low.

The present invention in its second aspect provides a display apparatus comprising:

a light-emitting member;

a transmissive panel configured to transmit a light emitted from the light-emitting member, based on image data; and

a detector configured to detect brightness of external light, wherein

in a case where the brightness of the external light is high, spatial high frequency components of the image data are less than the spatial high frequency components of the image data in a case where the brightness of the external light is low.

The present invention in its third aspect provides a control method of a display apparatus, wherein

the display apparatus includes:

a light-emitting member;

a first transmissive panel configured to transmit a light emitted from the light-emitting member; and

a second transmissive panel configured to display an image on a display surface by transmitting a light which is emitted from the light-emitting member and transmitted through the first transmissive panel,

the control method comprises:

a detection step of detecting brightness of external light; and

a transmission control step of executing control so that
the light emitted from the light-emitting member transmits through the first transmissive panel, based on first image data of which spatial high frequency components are less than spatial high frequency components of second image data, and
the light, which is emitted from the light-emitting member and transmitted through the first transmissive panel, transmits through the second transmissive panel based on the second image data, and

in a case where the brightness of the external light is high, the spatial high frequency components of the first image data are less than the spatial high frequency components of the first image data in a case where the brightness of the external light is low.

The present invention in its fourth aspect provides a non-transitory computer readable medium that stores a program, wherein

the program causes a computer to execute a control method of a display apparatus,

the display apparatus includes:

a light-emitting member;

a first transmissive panel configured to transmit a light emitted from the light-emitting member; and

a second transmissive panel configured to display an image on a display surface by transmitting a light which is emitted from the light-emitting member and transmitted through the first transmissive panel,

the control method includes:

a detection step of detecting brightness of external light; and

a transmission control step of executing control so that
the light emitted from the light-emitting member transmits through the first transmissive panel, based on first image data of which spatial high frequency components are less than spatial high frequency components of second image data, and
the light, which is emitted from the light-emitting member and transmitted through the first transmissive panel, transmits through the second transmissive panel based on the second image data, and

in a case where the brightness of the external light is high, the spatial high frequency components of the first image data are less than the spatial high frequency components of the first image data in a case where the brightness of the external light is low.

According to the present invention, an image in which various display interferences (e.g. halo interference, edge interference) are minimized can be displayed when the brightness of the external light is high.

Further features of the present invention will become apparent from the following description of exemplary embodiments with reference to the attached drawings.

### BRIEF DESCRIPTION OF THE DRAWINGS

FIG. 1 is a block diagram depicting a configuration example of a display apparatus according to Example 1;

FIG. 2 is a table indicating an example of a method of determining a filter number according to Example 1;

FIG. 3 is a table indicating an example of the filter according to Example 1;

FIG. 4 is a table indicating an example of the filter according to Example 1;

FIG. 5 is a table indicating an example of the filter according to Example 1;

FIGS. 6A to 6D are diagrams depicting examples of various gradation values according to Example 1;

FIGS. 7A and 7B are diagrams depicting an example of the principle of the display interference generation;

FIGS. 8A and 8B are diagrams depicting an example of the principle of the edge interference generation;

FIGS. 9A and 9B are diagrams depicting an example of the principle of the edge interference reduction (effect of Example 1);

FIG. 10 is a table indicating an example of a filter according to Example 1 (Modification 1);

FIG. 11 is a block diagram depicting a configuration example of a display apparatus according to Example 2; and

FIG. 12 is a table indicating an example of a method of determining a filter number according to Example 2.

### DESCRIPTION OF THE EMBODIMENTS

### Example 1

Example 1 of the present invention will be described. A display apparatus according to Example 1 has a light-emitting unit, a back panel and a front panel. In the following description, it is assumed that the direction from the light-emitting unit to the display surface (surface viewed by user) is the front direction. The back panel is a liquid crystal panel that is disposed on the front side (front face side) of the light-emitting unit, and the front panel is a liquid crystal panel that is disposed on the front side of the back panel. An image is displayed on the display surface when the light emitted from the light-emitting unit transmits through the back panel and the front panel in this sequence.

Each of the front panel and the back panel is a transmissive panel (transmissive type display panel), and need not be a liquid crystal panel. For example, at least one of the front panel and the back panel may be a micro electro mechanical system (MEMS) shutter type display panel.

Overview of Example 1

In Example 1, the back panel transmits the light emitted from the light-emitting unit based on the processed image data generated by suppressing the spatial high frequency components of the target image data. The front panel displays an image on the display surface by transmitting the light, which was emitted from the light-emitting unit and transmitted through the back panel, based on the target image data. Further, according to the display apparatus of Example 1, the processed image data is generated by suppressing the spatial high frequency components of the target image data at a higher degree of suppression when the brightness (intensity) of the external light to the display apparatus is higher, as compared with the case when the brightness of the external light is lower. Thereby when the brightness of the external light is high, an image, in which various display interferences (e.g. halo interference, edge interference) are minimized, can be displayed.

Configuration of Display Apparatus

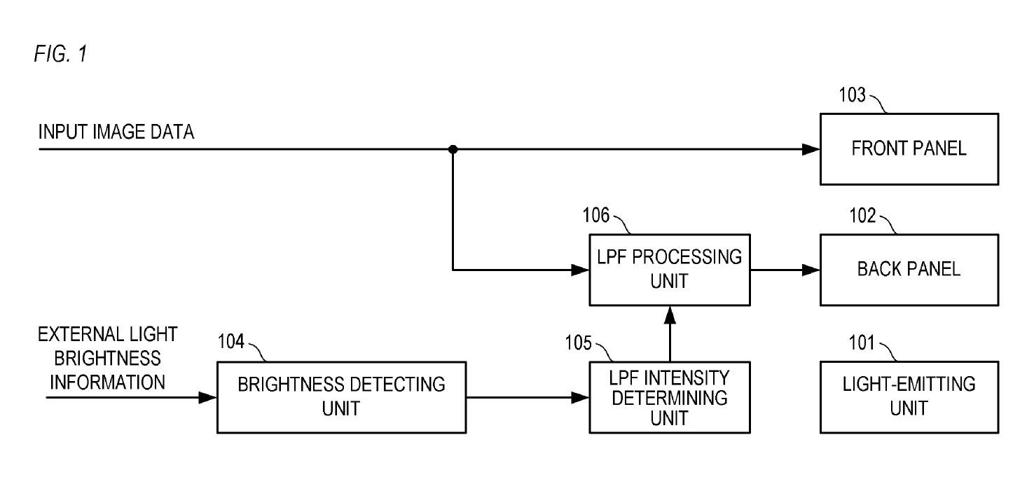

FIG. 1 is a block diagram depicting a configuration example of the display apparatus according to Example 1. As depicted in FIG. 1, the display apparatus according to Example 1 includes a light-emitting unit (back light module) 101, a back panel 102, a front panel 103, a brightness detecting unit 104, an LPF intensity determining unit 105, and an LPF processing unit 106.

The light-emitting unit 101 irradiates light to the rear surface of the back panel 102. The light-emitting unit 101 has at least one light source (light-emitting element). For the light source, an LED, an organic EL element, a cold cathode tube (CCFL) or the like can be used.

The back panel 102 is a liquid crystal panel disposed on the front side of the light-emitting unit 101. The back panel 102 transmits the light, emitted from the light-emitting unit 101, based on (in accordance with) the processed image data generated by suppressing the spatial high frequency components of the input image data (target image data). The input image data is image data which is input from an external apparatus (e.g. imaging apparatus, reproducing apparatus, storage apparatus) (not illustrated) to the display apparatus. In Example 1, the display characteristic of the back panel 102 is assumed to have the γ characteristic when γ value=1.0, in order to simplify the various processing described later.

The display apparatus may include a storage unit that stores the image data, and the image data recorded in the storage unit may be read from the storage unit as the target image data. The target image data is not limited to the image data output from the external apparatus and the image data recorded in the storage unit. For example, the display apparatus may include a processing unit which performs predetermined processing on the image data output from the external apparatus or the image data recorded in the storage unit, and the image data, after the predetermined processing is performed, may be used as the target image data. The predetermined processing is, for example, decode processing, resolution conversion processing, blur processing, edge enhancement processing, brightness conversion processing or color conversion processing.

The front panel 103 is a liquid crystal panel disposed on the front side of the back panel 102. In Example 1, the input image data is input to the front panel 103. Then the front panel 103 transmits the light, which was emitted from the light-emitting unit 101 and transmitted through the back panel 102, based on (in accordance with) the input image data, so as to display the image on the display surface. In Example 1, the display characteristic of the front panel 103 is assumed to have the γ characteristic when γ value=1.0, in order to simplify the various processing described later.

The display apparatus may include a processing unit which generates front image data (image data used for the front panel 103) from the input image data, and the front image data may be input to the front panel 103. Then the front panel 103 may transmits light, which was emitted from the light-emitting unit 101 and transmitted through the back panel 102, in accordance with the front image data.

The brightness detecting unit 104 detects the brightness of the external light (external light brightness) G to the display apparatus. In concrete terms, the external light brightness G is detected by the brightness sensor, and the brightness detecting unit 104 acquires the external light brightness information, which indicates the external light brightness from the brightness sensor. Acquisition of the external light brightness information can be regarded as “detection of the external light brightness G”. The brightness sensor may be fixed to the display apparatus, or may be detachable from the display apparatus.

The brightness detecting unit 104 detects (calculates; acquires) the external light reflection brightness T using the external light brightness and outputs the reflection brightness information, which indicates the external light reflection brightness T, to the LPF intensity determining unit 105. The external light reflection brightness T is the brightness of the reflected light, which is the external light reflected on the display surface. For example, the brightness detecting unit 104 calculates the external light reflection brightness T using the following Expression 1. In Expression 1, “LK” denotes the reflectivity of the display surface, and “π” denotes the ratio of the circumference of a circle to its diameter. The reflectivity LK is determined considering, for example, the characteristics of the back panel 102, the characteristics of the front panel 103, the visual environment, the diffuse reflectivity, the specular reflectivity and the like. The specular reflectivity is a reflectivity which is determined when the incident light is specularly reflected at an angle that is symmetrical with respect to the normal line, and the diffuse reflectivity is a reflectivity which is determined when the incident light is diffused and reflected in various directions.

T=G×LK÷π (Expression 1)

The LPF intensity determining unit 105 determines the degree of suppression, which is used in the suppression processing (spatial low-pass processing) to suppress the spatial high frequency components of the input image data, in accordance with the external light reflection brightness T. The suppression processing can be regarded as the “blurring processing to blur an image”, and the degree of suppression can be regarded as the “degree of blurring”. The suppression processing is not especially limited, but in Example 1, it is assumed that the suppression processing is the low-pass filter processing (LPF processing), and the degree of suppression (intensity of LPF processing; LPF intensity) is changed by changing the coefficient of the filter (filter coefficient) that is used for the LPF processing.

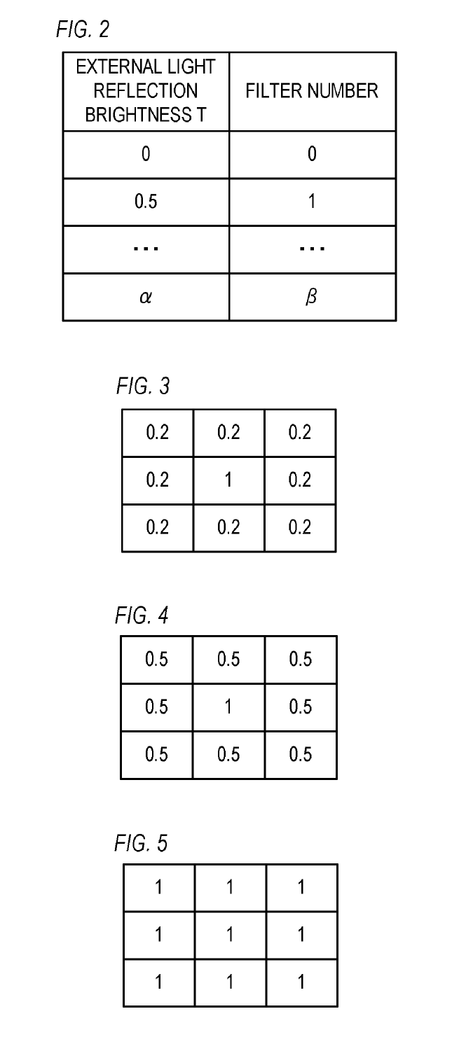

In Example 1, the LPF intensity determining unit 105 stores the relationship information on the correspondence between the external light reflection brightness T and the LPF intensity in advance, and determines the LPF intensity based on the relationship information and the external light reflection brightness T detected by the brightness detecting unit 104. In concrete terms, the LPF intensity determining unit 105 stores the table in FIG. 2 in advance. The table in FIG. 2 indicates the correspondence between the external light reflection brightness T and the number of the filter (identifier; filter number) used for the LPF processing. The LPF intensity determining unit 105 acquires the filter number corresponding to the external light reflection brightness T detected by the brightness detecting unit 104, from the table in FIG. 2, and outputs [the filter number] to the LPF processing unit 106.

In the table in FIG. 2, the filter number 0 corresponds to the external light reflection brightness T=0, the filter number 1 corresponds to the external light reflection brightness T=0.5, and the filter number β (>1) corresponds to the external light reflection brightness T=α (>0.5). FIG. 3 indicates a filter corresponding to the filter number 0, FIG. 4 indicates a filter corresponding to the filter number 1, and FIG. 5 indicates a filter corresponding to the filter number β. The intensity of the LPF processing using the filter in FIG. 4 is higher than the intensity of the LPF processing using the filter in FIG. 3, and the intensity of the LPF processing using the filter in FIG. 5 is higher than the intensity of the LPF processing using the filter in FIG. 4. In this way, in Example 1, when the external light reflection brightness T (external light brightness G) is high, an LPF intensity, that is higher than the case when the external light reflection brightness T (external light brightness G) is low, is determined.

The LPF intensity determining unit 105 may determine the LPF intensity using the external light brightness instead of the external light reflection brightness T. Information other than the filter number (e.g. filter coefficient, LPF intensity) may be determined. For the relationship information (e.g. information on correspondence between the external light reflection brightness T and the LPF intensity, information on the corresponding between the external light brightness G and the LPF intensity), a table may be used or a function may be used.

The LPF processing unit 106 generates the processed image data by suppressing the spatial high frequency components of the input image data at a degree of the suppression determined by the LPF intensity determining unit 105. In concrete terms, the LPF processing unit 106 performs the LPF processing on the input image data using a filter having the filter number output from the LPF intensity determining unit 105. As a result, the processed image data is generated. The LPF processing unit 106 outputs the processed image data to the back panel 102.

In the LPF processing, the gradation value V (x, y) of the input image data is converted into the gradation value W (x, y) of the processed image data using the following Expression 2. The gradation values V (x, y) and W (x, y) are gradation values at a horizontal position (position in the horizontal direction (lateral direction) of the image) x, and a vertical position (position in the vertical direction (longitudinal direction) of the image) y. In Expression 2, “V (x+i, y+j)” denotes an input gradation value (gradation value of input image data) at the horizontal position x+i and the vertical position y+j, and “K(i, j)” denotes a filter coefficient at the horizontal position i and the vertical position j. The size of the filter (filter size) that is used for the LPF processing is not especially limited, but Expression 2 is an expression when the filter size is a size totaling 9 pixels (3 pixels in horizontal direction×3 pixels in vertical direction).

$$\begin{matrix}[ Math . 1 ] & \\ W ( x , y ) = {\sum }_{i = - 1}^{1} {\sum }_{j = - 1}^{1} V ( x + i , y + j ) \times K ( i , j ) & ( Expression 2 )\end{matrix}$$

The display apparatus may include a processing unit that generates back image data (image data for back panel 102) from the input image data, and the LPF processing unit 106 may generates the processed image data by performing the LPF processing on the back image data.

Principle of Display Interference Generation

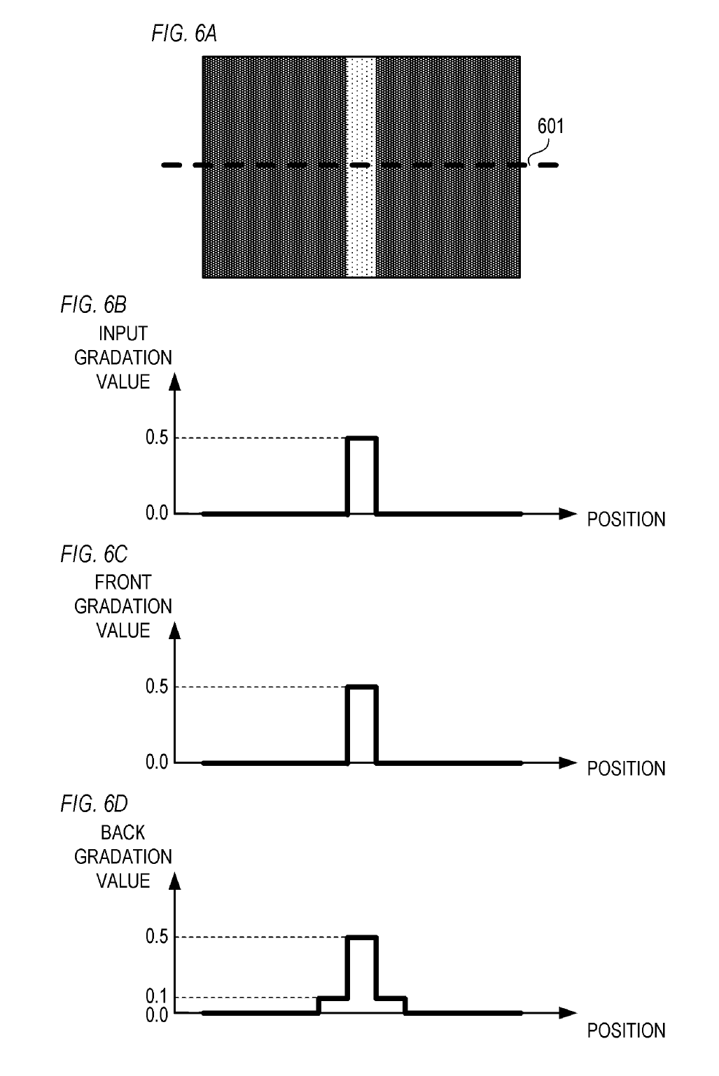

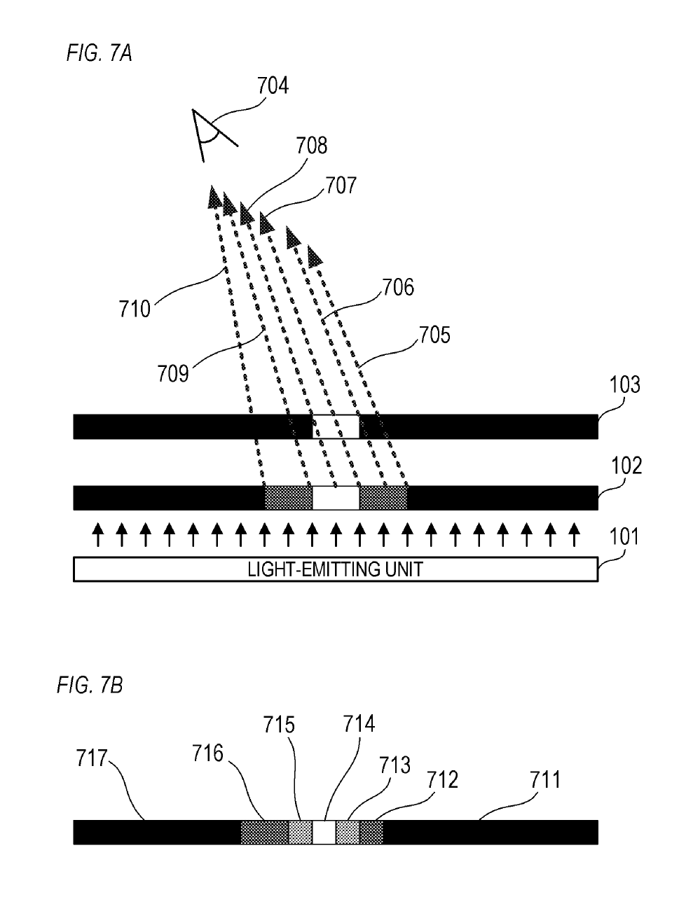

The principle of the display interference (halo interference and edge interference) generation will be described with reference to FIGS. 6A to 6D, 7A and 7B. In the following, the horizontal direction of the image will be described to simplify description, but the same description as the case of the horizontal direction is applicable to other directions (e.g. vertical direction) of the image.

FIG. 6A is an example of an image expressed by the input image data. In the image in FIG. 6A, a white line, gradation value of which is 0.5, is drawn on the black background gradation value of which is 0.0. The white line is drawn along the vertical direction at the center in the horizontal direction. FIG. 6B is a distribution of an input gradation value (gradation value of the input image data) on a broken line 601 in FIG. 6A. FIG. 6C is an example of a distribution of a front gradation value (gradation value that is input to the front panel 103) corresponding to the input gradation value on the broken line 601 in FIG. 6A. In Example 1, the front gradation value is equal to the input gradation value. FIG. 6D is an example of a distribution of a back gradation value (gradation value that is input to the back panel 102; gradation value of the processing image data) corresponding to the input gradation value on the broken line 601 in FIG. 6A. In FIG. 6D, the spatial frequency between the white line and the black line is suppressed. The distribution in FIG. 6D is the distribution generated when the filter in FIG. 3 is used. Therefore in FIG. 6D, the back gradation value at the position adjacent to the white line is: 0.1 (=0.5×0.2+0.0×1+0.0×0.2).

FIG. 7A is a cross-sectional view of the display apparatus sectioned at a line corresponding to the broken line 601 in FIG. 6A. In FIG. 7A, the eye 704 of the user is located at a position of viewing the display surface from the diagonal direction (direction inclined from the normal line direction of the display surface). In FIG. 7A, external light does not exist. In the following, for each of the back panel 102 and the front panel 103, a portion gradation value of which is 0.5 is called a “white portion”. A portion gradation value of which is 0.1 and which is adjacent to the right side of the white portion is called a “right side gray portion”, and a portion gradation value of which is 0.1 and which is adjacent to the left side of the white portion is called a “left side gray portion”. A portion gradation value of which is 0.0 and which is adjacent to the right side of the white portion is called a “right side black portion”, and the portion gradation value of which is 0.0 and which is adjacent to the left side of the white portion is called a “left side black portion”.

In FIG. 7A, the light 705 is a light which transmits through the right edge of the right side gray portion of the back panel 102, transmits through the right side black portion of the front panel 103, and enters the eye 704. The light 706 is a light which transmits through the right side gray portion of the back panel 102, transmits through the boundary between the right side black portion and the white portion of the front panel 103, and enters the eye 704. The light 707 is a light which transmits through the boundary between the right side gray portion and the white portion of the back panel 102, transmits through the white portion of the front panel 103, and enters the eye 704. The light 708 is a light which transmits through the white portion of the back panel 102, transmits through the boundary between the white portion and the left side black portion of the front panel 103, and enters the eye 704. The light 709 is a light which transmits through the boundary between the white portion and the left side gray portion of the back panel 102, transmits through the left side black portion of the front panel 103, and enters the eye 704. The light 710 is a light which transmits through the left edge of the left side gray portion of the back panel 102, transmits through the left side black portion of the front panel 103, and enters the eye 704.

FIG. 7B indicates a view of the display image (image displayed on the display surface) at a portion corresponding to the broken line 601 in FIG. 6A. The view in FIG. 7B is a view from the eye 704 in FIG. 7A. In FIG. 7B, the display surface is divided into seven regions 711 to 717.

The region 711 is a region from the right edge of the display surface (front panel 103) to the position where the light 705 in FIG. 7A transmits through the front panel 103, and corresponds to the black background in FIG. 6A. In the case of the region 711, the light, which transmitted through the back panel 102 at the transmittance of the back gradation value 0.0, and then transmitted through the front panel 103 at the transmittance of the front gradation value 0.0, enters the eye 704. Therefore, the user recognizes the region 711 as a black region.

The region 712 is a region from the position where the light 705 in FIG. 7A transmits through the front panel 103 to the position where the light 706 in FIG. 7A transmits through the front panel 103, and corresponds to the black background in FIG. 6A. In the case of the region 712, the light, which transmitted through the back panel 102 at the transmittance of the back gradation value 0.1 instead of the back gradation value 0.0, and then transmitted through the front panel 103 at the transmittance of the front gradation value 0.0, enters the eye 704. Therefore, even if the region 712 corresponds to the black background, the user recognizes the region 712 as a region that is lighter than black. In other words, the halo interference is recognized in the region 712.

The region 713 is a region from the position where the light 706 in FIG. 7A transmits through the front panel 103 to the position where the light 707 in FIG. 7A transmits through the front panel 103, and corresponds to the white line in FIG. 6A. In the case of the region 713, the light, which transmitted through the back panel 102 at the transmittance of the back gradation value 0.1 instead of the back gradation value 0.5, and then transmitted through the front panel 103 at the transmittance of the front gradation value 0.5, enters the eye 704. Therefore, even if the region 713 corresponds to the white line, the user recognizes the region 713 as a region that is darker than white. In other words, the edge interference is recognized in the region 713.

The region 714 is a region from the position where the light 707 in FIG. 7A transmits through the front panel 103 to the position where the light 708 in FIG. 7A transmits through the front panel 103, and corresponds to the white line in FIG. 6A. In the case of the region 714, the light, which transmitted through the back panel 102 at the transmittance of the back gradation value 0.5, and then transmitted through the front panel 103 at the transmittance of the front gradation value 0.5, enters the eye 704. Therefore, the user recognizes the region 714 as a white region.

The region 715 is a region from the position where the light 708 in FIG. 7A transmits through the front panel 103 to the position where the light 709 in FIG. 7A transmits through the front panel 103, and corresponds to the black background in FIG. 6A. In the case of the region 715, the light, which transmitted through the back panel 102 at the transmittance of the back gradation value 0.5 instead of the back gradation value 0.0, and then transmitted through the front panel 103 at the transmittance of the front gradation value 0.0, enters the eye 704. Therefore, even if the region 715 corresponds to the black background, the user recognizes the region 715 as a region that is lighter than black. In other words, the halo interference is recognized in the region 715.

The region 716 is a region from the position where the light 709 in FIG. 7A transmits through the front panel 103 to the position where the light 710 in FIG. 7A transmits through the front panel 103, and corresponds to the black background in FIG. 6A. In the case of the region 716, the light, which transmitted through the back panel 102 at the transmittance of the back gradation value 0.1 instead of the back gradation value 0.0, and then transmitted through the front panel 103 at the transmittance of the front gradation value 0.0, enters the eye 704. Therefore, even if the region 716 corresponds to the black background, the user recognizes the region 716 as a region that is lighter than black. In other words, the halo interference is recognized in the region 716.

The region 717 is a region from the position where the light 710 in FIG. 7A transmits through the front panel 103 to the left edge of the display surface (front panel 103), and corresponds to the black background in FIG. 6A. In the case of the region 717, the light, which transmitted through the back panel 102 at the transmittance of the back gradation value 0.0, and then transmitted through the front panel 103 at the transmittance of the front gradation value 0.0, enters the eye 704. Therefore, the user recognizes the region 717 as a black region.

As described below, when no external light exists, the halo interference and the edge interference are generated by suppressing the spatial high frequency components of the image displayed on the back panel 102, in order to reduce double images.

Principle of Edge Interference Generation

The principle of the edge interference generation in the environment where the external light brightness G (external light reflection brightness T) is high will be described. Here it is assumed that the filter that is used for the LPF processing is the same as the filter in FIG. 3, and the gradation values (input gradation value, front gradation value and back gradation value) that are the same as FIG. 6B to FIG. 6D are used.

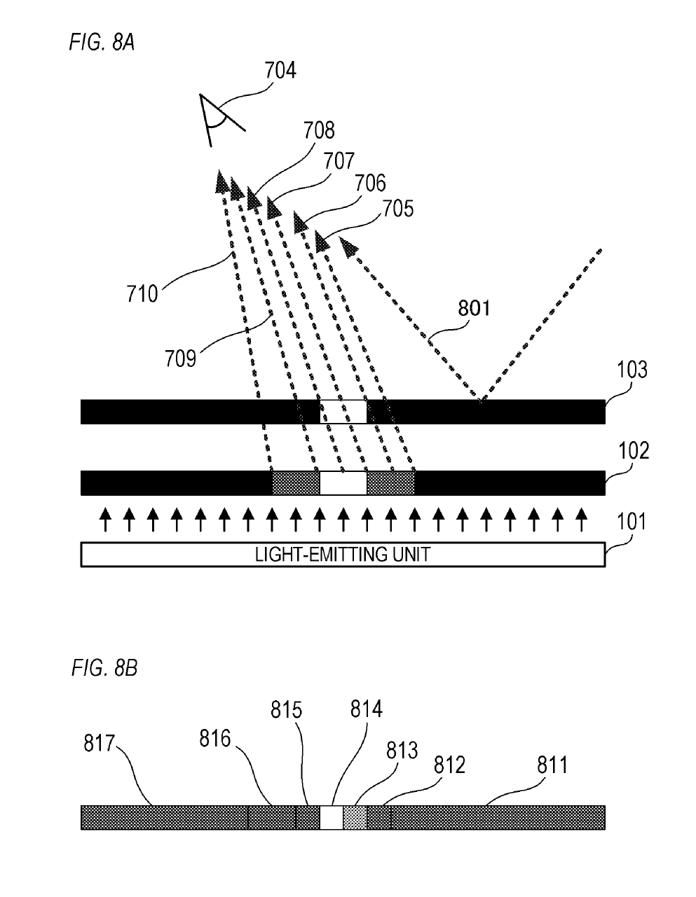

FIG. 8A is a cross-sectional view of the display apparatus sectioned at a line corresponding to the broken line 601 in FIG. 6A. In FIG. 8A, an external light exists. The light 705 to 710 in FIG. 8A are the same as the light 705 to 710 in FIG. 7A. In FIG. 8A, the external light, reflected on the display surface, becomes the reflected light 801, and the reflected light 801 enters the eye 704.

FIG. 8B indicates a view of the display image in a portion corresponding to the broken line 601 in FIG. 6A. The view in FIG. 8B is a view from the eye 704 in FIG. 8A. In FIG. 8B, the display surface is divided into seven regions 811 to 817.

The region 811 corresponds to the region 711 in FIG. 7B. However, since the reflected light 801 enters the eye 704, the user recognizes the region 811 not as a black region but as a black floating region, which is lighter by the amount of brightness (light quantity) of the reflected light 801.

The region 812 corresponds to the region 712 in FIG. 7B. However, since the reflected light 801 enters the eye 704, the user recognizes the region 812 not as the halo interference (which is hard to recognize), but as a black floating region which is lighter by the amount of the brightness of the reflected light 801. The brightness of the reflected light 801 is at least the brightness of the region 812 (at least the brightness of the light which transmits through the back panel 102 and the front panel 103, and enters the eye 704 from the region 812), for example.

The region 813 corresponds to the region 713 in FIG. 7B. In the case of the region 813, the light, which transmitted through the back panel 102 at the transmittance of the back gradation value 0.1 instead of the back gradation value 0.5, and then transmitted through the front panel 103 at the transmittance of the front gradation value 0.5, enters the eye 704, similarly to the case of the region 713 in FIG. 7B. Therefore, even if the region 813 corresponds to the white line in FIG. 6A, the user recognizes the region 813 as a region that is darker than white (the region 814, to be more concrete). In other words, the edge interference is recognized in the region 813.

The region 814 corresponds to the region 714 in FIG. 7B. In the case of the region 814, the light, which transmitted through the back panel 102 at the transmittance of the back gradation value 0.5, and then transmitted through the front panel 103 at the transmittance of the front gradation value 0.5, enters the eye 704, similarly to the case of the region 714. Therefore, the user recognizes the region 814 as a white region (e.g. a white region that is lighter than the region 714).

The region 815 corresponds to the region 715 in FIG. 7B. However, since the reflected light 801 enters the eye 704, the user recognizes the region 815 not as the halo interference (which is hard to recognize), but as a black floating region, which is lighter by the amount of the brightness of the reflected light 801. The brightness of the reflected light 801 is at least the brightness of the region 815 (at least the brightness of the light which transmits through the back panel 102 and the front panel 103, and enters the eye 704 from the region 815), for example.

The region 816 corresponds to the region 716 in FIG. 7B. However, since the reflected light 801 enters the eye 704, the user recognizes the region 816 not as the halo interference (which is hard to recognize), but as a black floating region, which is lighter by the amount of the brightness of the reflected light 801. The brightness of the reflected light 801 is at least the brightness of the region 816 (at least the brightness of the light which transmits through the back panel 102 and the front panel 103, and enters the eye 704 from the region 816), for example.

The region 817 corresponds to the region 717 in FIG. 7B. However, since the reflected light 801 enters the eye 704, the user recognizes the region 817 not as a black region, but as a black floating region, which is lighter by the amount of the brightness of the reflected light 801.

As described above, when external light exists, the halo interference is decreased by the external light (reflected light, to be more specific), even if the spatial high frequency components of the image displayed on the back panel 102 are suppressed, in order to reduce double images. However, the edge interference still remains.

Principle of Edge Interference Reduction

The principle of the edge interference reduction in Example 1 will be described next. As mentioned above, according to Example 1, the processed image data (back gradation value) is generated by the LPF processing with high intensity when the external light brightness G (external light reflection brightness T) is high. Here it is assumed that the input gradation value is the same as the input gradation value in FIG. 6B, and the front gradation value is the same as the front gradation value in FIG. 6C. However, since the external light brightness G (external light reflection brightness T) is high, the filter that is used for the LPF processing is different from the filter in FIG. 3, and the back gradation value is different from the back gradation value in FIG. 6D. In concrete terms, it is assumed that the back gradation value at a position adjacent to the white line in FIG. 6A is not 0.1 but 0.5.

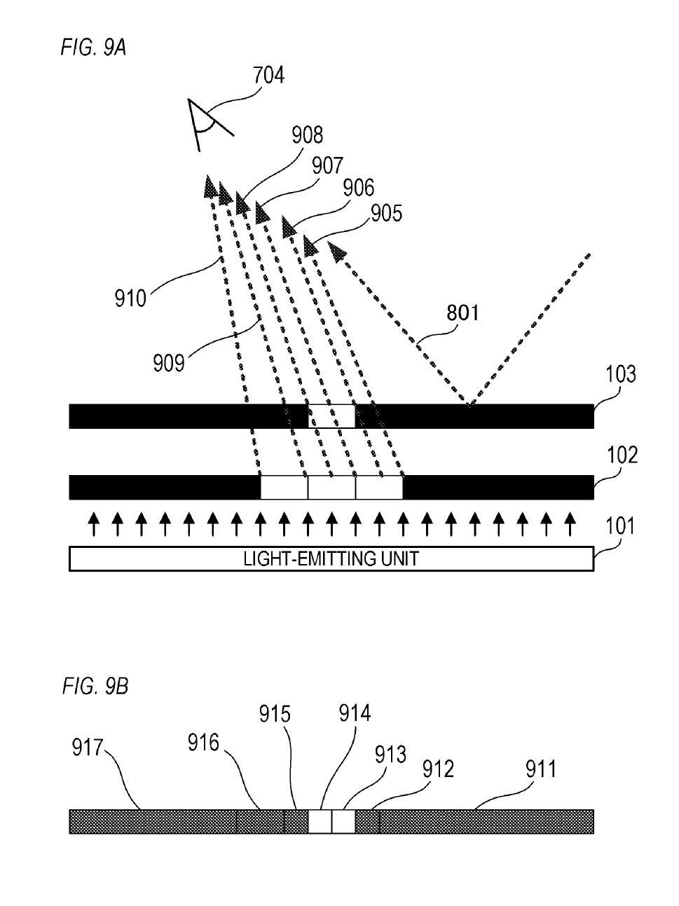

FIG. 9A is a cross-sectional view of the display apparatus sectioned at a line corresponding to the broken line 601 in FIG. 6A. In FIG. 9A, an external light exists. The light 905 to 910 in FIG. 9A corresponds to the light 705 to 710 in FIG. 7A respectively. The light 905 is a light which transmits through the right edge of the white portion of the back panel 102, transmits through the right side black portion of the front panel 103, and enters the eye 704. The light 906 is a light which transmits through the white portion of the back panel 102, transmits through the boundary between the right side black portion and the white portion of the front panel 103, and enters the eye 704. The light 907 is a light which transmits through the white portion of the back panel 102, transmits through the white portion of the front panel 103, and enters the eye 704. The light 908 is a light which transmits through the white portion of the back panel 102, transmits through the boundary between the white portion and the left side black portion of the front panel 103, and enters the eye 704. The light 909 is a light which transmits through the white portion of the back panel 102, transmits through the left side black portion of the front panel 103, and enters the eye 704. The light 910 is a light which transmits through the left edge of the white portion of the back panel 102, transmits through the left side black portion of the front panel 103, and enters the eye 704.

FIG. 9B indicates a view of the display image at a portion corresponding to the broken line 601 in FIG. 6A. The view in FIG. 9B is a view from the eye 704 in FIG. 9A. In FIG. 9B, the display surface is divided into seven regions 911 to 917.

The region 911 corresponds to the region 711 in FIG. 7B. In concrete terms, the region 911 is a region from the right edge of the display surface to the position where the light 905 in FIG. 9A transmits through the front panel 103, and corresponds to the black background in FIG. 6A. In the case of the region 911, the light which transmitted through the back panel 102 at the transmittance of the back gradation value 0.0, and then transmitted through the front panel 103 at the transmittance of the front gradation value 0.0, enters the eye 704, similarly to the case of the region 711. However, since the reflected light 801 enters the eye 704, the user recognizes the region 911 not as a black region, but as a black floating region, which is lighter by the amount of the brightness of the reflected light 801.

The region 912 corresponds to the region 712 in FIG. 7B. In concrete terms, the region 912 is a region from the position where the light 905 in FIG. 9A transmits through the front panel 103 to the position where the light 906 in FIG. 9A transmits through the front panel 103, and corresponds to the black background in FIG. 6A. In the case of the region 912, the light which transmitted through the back panel 102 at the transmittance of the back gradation value 0.5 instead of the back gradation value 0.0, and then transmitted through the front panel 103 at the transmittance of the front gradation value 0.0, enters the eye 704. However, since the reflected light 801 enters the eye 704, the user recognizes the region 912 not as the halo interference (which is hard to recognize), but as a black floating region, which is lighter by the amount of the brightness of the reflected light 801. The brightness of the reflected light 801 is at least the brightness of the region 912 (at least the brightness of the light which transmits through the back panel 102 and the front panel 103, and enters the eye 704 from the region 912), for example.

The region 913 corresponds to the region 713 in FIG. 7B. In concrete terms, the region 913 is a region from the position where the light 906 in FIG. 9A transmits through the front panel 103 to the position where the light 907 in FIG. 9A transmits through the front panel 103, and corresponds to the white line in FIG. 6A. In the case of the region 913, the light, which transmitted through the back panel 102 at the transmittance of the back gradation value 0.5, and then transmitted through the front panel 103 at the transmittance of the front gradation value 0.5, enters the eye 704. Therefore, the user recognizes the region 913 not as the edge interference (which is hard to recognize), but as a white region.

The region 914 corresponds to the region 714 in FIG. 7B. In concrete terms, the region 914 is a region from the position where the light 907 in FIG. 9A transmits through the front panel 103 to the position where the light 908 in FIG. 9A transmits through the front panel 103, and corresponds to the white line in FIG. 6A. In the case of the region 914, the light, which transmitted through the back panel 102 at the transmittance of the back gradation value 0.5, and then transmitted through the front panel 103 at the transmittance of the front gradation value 0.5, enters the eye 704, similarly to the case of the region 714. Therefore, the user recognizes the region 914 as a white region.

The region 915 corresponds to the region 715 in FIG. 7B. In concrete terms, the region 915 is a region from the position where the light 908 in FIG. 9A transmits through the front panel 103 to the position where the light 909 in FIG. 9A transmits through the front panel 103, and corresponds to the black background in FIG. 6A. In the case of the region 915, the light, which transmitted through the back panel 102 at the transmittance of the back gradation value 0.5 instead of the back gradation value 0.0, and then transmitted through the front panel 103 at the transmittance of the front gradation value 0.0, enters the eye 704, similarly to the case of the region 715. However, since the reflected light 801 enters the eye 704, the user recognizes the region 915 not as the halo interference (which is hard to recognize), but as a black floating region, which is lighter by the amount of the brightness of the reflected light 801. The brightness of the reflected light 801 is at least the brightness of the region 915 (at least the brightness of the light which transmits through the back panel 102 and the front panel 103, and enters the eye 704 from the region 915), for example.

The region 916 corresponds to the region 716 in FIG. 7B. In concrete terms, the region 916 is a region from the position where the light 909 in FIG. 9A transmits through the front panel 103 to the position where the light 910 in FIG. 9A transmits through the front panel 103, and corresponds to the black background in FIG. 6A. In the case of the region 916, the light, which transmitted through the back panel 102 at the transmittance of the back gradation value 0.5 instead of the back gradation value 0.0, and then transmitted through the front panel 103 at the transmittance of the front gradation value 0.0, enters the eye 704. However, since the reflected light 801 enters the eye 704, the user recognizes the region 916 not as the halo interference (which is hard to recognize), but as a black floating region, which is lighter by the amount of the brightness of the reflected light 801. The brightness of the reflected light 801 is at least the brightness of the region 916 (at least the brightness of the light which transmits through the back panel 102 and the front panel 103, and enters the eye 704 from the region 916), for example.

The region 917 corresponds to the region 717 in FIG. 7B. In concrete terms, the region 917 is a region from the position where the light 910 in FIG. 9A transmits through the front panel 103 to the left edge of the display surface, and corresponds to the black background in FIG. 6A. In the case of the region 917, the light, which transmitted through the back panel 102 at the transmittance of the back gradation value 0.0, and then transmitted through the front panel 103 at the transmittance of the front gradation value 0.0, enters the eye 704, similarly to the case of the region 717. However, since the reflected light 801 enters the eye 704, the user recognizes the region 917 not as the black region, but as a black floating region, which is lighter by the amount of the brightness of the reflected light 801.

As described above, when the external light brightness G (external light reflection brightness T) is high, the user can recognize a display image, in which the halo interference and the edge interference are minimized, by increasing the LPF intensity. In concrete terms, the halo interference is reduced by the external light (reflected light), and the edge interference is reduced by the high LPF intensity.

Conclusion

As described above, according to Example 1, the processed image data is generated by suppressing the spatial high frequency components of the target image data at a higher degree of suppression when the external light brightness is higher, as compared with the case when the external light brightness is lower. Thereby when the external light brightness is high, an image, in which various display interferences (e.g. halo interference, edge interference) are minimized, can be displayed.

Modification 1

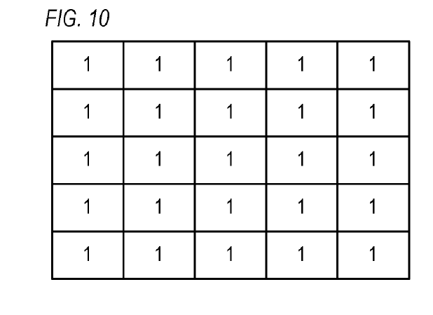

In the description of Example 1, the LPF intensity (degree of suppression of spatial high frequency components) is changed by changing the filter coefficient of the LPF processing, but the present invention is not limited to this. For example, the LPF intensity may be changed by changing the filter size of the LPF processing. In concrete terms, when the external light reflection brightness T (external light brightness G) is high, the filter used for the LPF processing may be changed from the filter in FIG. 3 to the filter in FIG. 10. The filter size in FIG. 3 is 3 pixels in the horizontal direction×3 pixels in the vertical direction, totaling 9 pixels, but the filter size in FIG. 10 is 5 pixels in the horizontal direction×5 pixels in the vertical direction, totaling 25 pixels. The intensity of the LPF processing, in the case of using the filter in FIG. 10, is higher than the intensity of the LPF processing in the case of using the filter in FIG. 3. One of the filter coefficient and the filter size may be changed, or both of the filter coefficient and the filter size may be changed.

Modification 2

In Example 1, the concrete values of the LPF intensity (degree of suppression of the spatial high frequency components) were not described. However, it is preferable to change the LPF intensity so that the display brightness (brightness of the display surface; brightness of the display image) in the dark portion of the target image data, the dark portion being adjacent to the light portion of the target image data, is at least the external light reflection brightness T detected by the brightness detecting unit 104. Thereby recognition of the edge interference can be prevented with higher certainty. The light portion of the target image data is an image region in which the gradation value of the target image data is at least a light portion threshold, for example. The dark region of the target image data is an image region in which gradation value of the target image data is not more than a dark portion threshold (<light portion threshold).

Here the display brightness of the dark portion of the target image data adjacent to the light portion of the target image data is called the “brightness KK”. The display brightness of black, in the case of the transmittance of the back panel 102 in the upper limit, is called the “brightness AK”. Since the upper limit of the brightness KK is the brightness AK, it is preferable that the LPF intensity is determined to satisfy the following Expression 3.

T≤KK≤AK (Expression 3)

If the LPF intensity is determined such that the brightness KK matches with the external light reflection brightness T, both the reduction of the edge interference and the improvement of the display contrast (contrast gradation) of the display image can be implemented. The improvement of the display contrast can be regarded as “decreasing the black level in the display image”. If the reduction of the edge interference is more critical than the improvement of the display contrast, the LPF intensity may be determined such that the brightness KK is higher than the external light reflection brightness T. As the brightness KK becomes higher, the edge interference is reduced more. If the improvement of the display contrast is more critical than the reduction of the edge interference, the LPF intensity may be determined such that the brightness KK is lower than the external light reflection brightness T. As the brightness KK becomes lower, the display contrast is improved more. The relationship between the brightness KK and the external light reflection brightness T is not especially limited. For example, the relationship between the brightness KK and the external light reflection brightness T may be specified by the user, or may be determined in accordance with the image quality mode.

### Example 2

Example 2 of the present invention will be described next. In Example 1, a case of determining the LPF intensity (degree of suppression of the spatial high frequency components), in accordance with the external light brightness G (external light reflection brightness T), was described. In Example 2, a case of determining the LPF intensity by additionally considering the light-emitting brightness of the light-emitting unit 101 will be described. In the following, the aspects (configuration and processing) that are different from Example 1 will be described in detail, and description on the aspects that are the same as Example 1 will be omitted.

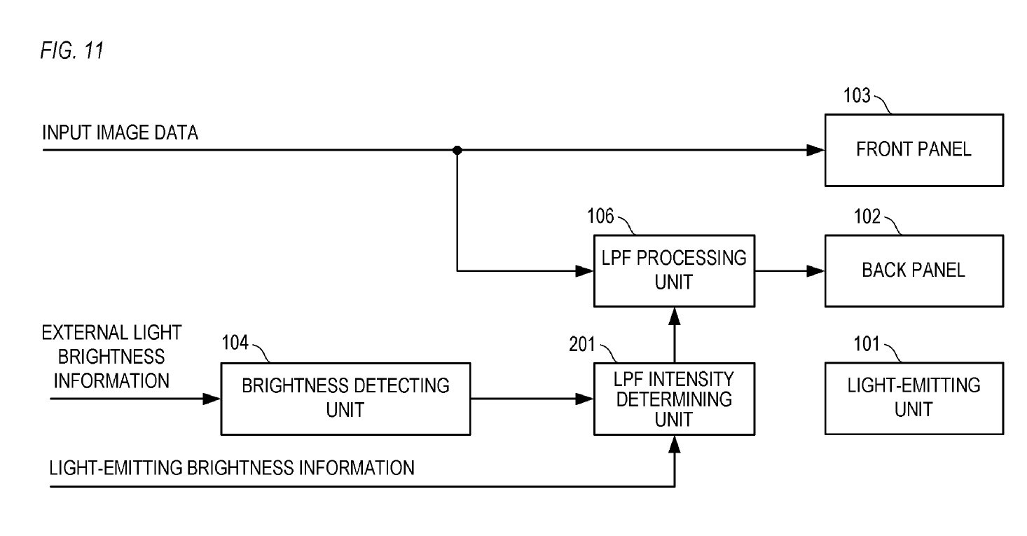

FIG. 11 is a block diagram depicting a configuration example of the display apparatus according to Example 2. As depicted in FIG. 11, the configuration of the display apparatus according to Example 2 is approximately the same as the configuration of the display apparatus according to Example 1 (FIG. 1). The display apparatus according to Example 2 includes an LPF intensity determining unit 201, instead of the LPF intensity determining unit 105 of Example 1.

The LPF intensity determining unit 201 acquires the reflection brightness information which indicates the external light reflection brightness T from the brightness detecting unit 104, similarly to the LPF intensity determining unit 105 in Example 1. Further, the LPF intensity determining unit 201 acquires the light-emitting brightness information which indicates the light-emitting brightness BL of the light-emitting unit 101. Then the LPF intensity determining unit 201 determines the LPF intensity in accordance with the external light reflection brightness T and the light-emitting brightness BL.

For example, the display apparatus includes a control unit configured to control the light-emitting brightness of the light-emitting unit 101 in accordance with the user operation (e.g. user operation to specify the display brightness), the operation mode of the display apparatus, the operation environment of the display apparatus, the type of the target image data, the brightness of the target image data and the like. Then the LPF intensity determining unit 201 acquires the light-emitting brightness information from the control unit. The method of acquiring the light-emitting brightness information is not especially limited. For example, the display apparatus may include a brightness sensor which detects the light-emitting brightness of the light-emitting unit 101. The LPF intensity determining unit 201 may acquire the light-emitting brightness information from the brightness sensor.

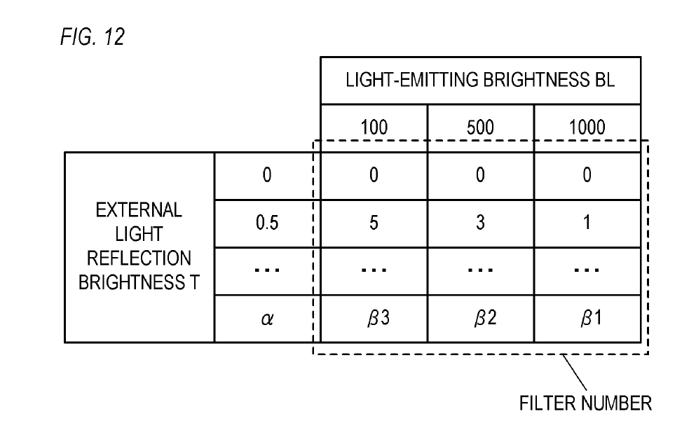

In Example 2, the LPF intensity determining unit 201 stores relationship information on the correspondence of the external light reflection brightness T, the light-emitting brightness BL and the LPF intensity. Then the LPF intensity determining unit 201 determines the LPF intensity based on the relationship information, the external light reflection brightness T indicated by the reflection brightness information, and the light-emitting brightness BL indicated by the light-emitting brightness information. In concrete terms, the LPF intensity determining unit 201 stores a table in FIG. 12 in advance. The table in FIG. 12 indicates the correspondence of the external light reflection brightness T, the light-emitting brightness BL and the filter number. The LPF intensity determining unit 201 acquires the filter number corresponding to the combination of the external light reflection brightness T indicated by the reflection brightness information and the light-emitting brightness BL indicated by the light-emitting brightness information, from the table in FIG. 12, and outputs the acquired filter number to the LPF processing unit 106.

In Example 2, the LPF intensity is higher as the filter number is larger. In FIG. 12, β1>1, β2>3, β3>5 and β3>β2>β1. According to the table in FIG. 12, the filter number is larger as the external light reflection brightness T (external light brightness G) is higher if the light-emitting brightness BL is fixed. In other words, the LPF intensity is higher as the external light reflection brightness T (external light brightness G) is higher if the light-emitting brightness BL is fixed. Further, the filter number is larger as the light-emitting brightness BL is lower if the external light reflection brightness T (external light brightness G) is fixed. In other words, the LPF intensity is higher as the light-emitting brightness BL is lower if the external light reflection brightness T (external light brightness G) is fixed.

If the LPF intensity is fixed, the display brightness decreases as the light-emitting brightness BL decreases. As mentioned above, in Example 2, a higher LPF intensity is determined when the light-emitting brightness BL is lower, as compared with the case when the light-emitting brightness BL is higher if the external light reflection brightness T is fixed. Therefore, when the light-emitting brightness BL is lower, the display brightness of the dark portion (e.g. black) of the target image data can be increased more compared to the case when the light-emitting brightness BL is higher, whereby the edge interference can be reduced at even higher precision.

As described above, according to Example 2, the processed image data is generated by suppressing the spatial high frequency components of the target image data at a degree of suppression which is determined by further considering the light-emitting brightness of the light-emitting unit. In concrete terms, if the external light brightness is fixed, the spatial high frequency components of the target image data are suppressed at a higher degree of suppression when the light-emitting brightness of the light-emitting unit is lower, as compared with the case when the light-emitting brightness of the light-emitting unit is higher. Thereby an image in which the edge interference is further decreased can be displayed.

Modification 3

In the description of Examples 1 and 2, the LPF intensity (degree of suppression of the spatial high frequency components) is changed to reduce the edge interference and the like. However, in some cases when the light-emitting brightness of the light-emitting unit 101 is low, the display brightness of the dark portion of the target image data (dark portion of the target image data that is adjacent to the light portion of the target image data) may not reach at least the external light reflection brightness T even if the LPF intensity is increased. In this case, the edge interference is reduced, but the visibility of the image region, in which the display brightness is not more than the external light reflection brightness T, drops. Therefore, in this case, it is preferable that the control unit (not illustrated) of the display apparatus increases the transmittance of the front panel 103, so that the display brightness of the dark portion of the target image data becomes at least the external light reflection brightness T. The control unit may increase the light-emitting brightness of the light-emitting unit 101, so that the display brightness of the dark portion of the target image data becomes at least the external light reflection brightness T. One of the transmittance of the front panel 103 and the light-emitting brightness of the light-emitting unit 101 may be increased, or both the transmittance of the front panel 103 and the light-emitting brightness of the light-emitting unit 101 may be increased. Thereby both the reduction of the edge interference and the improvement of the display contrast (contrast (gradation) of the display image) can be implemented at higher certainty.

The increase in the transmittance of the front panel 103, the increase in the light-emitting brightness of the light-emitting unit 101 and the like may be performed in cases other than cases when the display brightness of the dark portion of the target image data does not reach at least the external light reflection brightness T, even if the LPF intensity is enhanced.

Each functional unit of Examples 1 and 2 may or may not be independent hardware. The functions of at least two functional units may be implemented by common hardware. Each of a plurality of functions of one functional unit may be implemented by independent hardware respectively. At least two functions of one functional unit may be implemented by common hardware. Each functional unit may or may not be implemented by hardware. For example, the apparatus may include a processor and a memory storing a control program. Then the functions of at least a part of the functional units of the apparatus may be implemented by the processor reading the control program from the memory, and executing the control program.

Examples 1 and 2 are merely examples, and the configurations acquired by appropriately modifying or changing the configurations of Examples 1 and 2, within the scope of the spirit of the present invention, are also included in the present invention. The configurations acquired by appropriately combining the configurations of Examples 1 and 2 are also included in the present invention.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2018-026138, filed on Feb. 16, 2018, which is hereby incorporated by reference herein in its entirety.

What is claimed is:

1. A display apparatus comprising:
a light-emitting member;
a first transmissive panel configured to transmit a light emitted from the light-emitting member, based on first image data of which spatial high frequency components are less than spatial high frequency components of second image data;
a second transmissive panel configured to display an image on a display surface by transmitting a light, which is emitted from the light-emitting member and transmitted through the first transmissive panel, based on the second image data; and
a detector configured to detect brightness of external light, wherein
in a case where the brightness of the external light is high, the spatial high frequency components of the first image data are less than the spatial high frequency components of the first image data in a case where the brightness of the external light is low.

2. The display apparatus according to claim 1, further comprising at least one processor that operates as a generating unit configured to generate the first image data by suppressing the spatial high frequency components of the second image data at a degree of suppression, wherein
in a case where the brightness of the external light is high, the degree of suppression is higher than the degree of suppression in a case where the brightness of the external light is low.

3. The display apparatus according to claim 2, wherein
the processing to suppress the spatial high frequency components of the second image data is low-pass filter processing, and
the generating unit changes the degree of suppression by changing at least one of a size and a coefficient of a filter which is used for the low-pass filter processing.

4. The display apparatus according to claim 2, wherein the generating unit changes the degree of suppression so that display brightness of a dark portion of the second image data, the dark portion being adjacent to a light portion of the second image data, is not lower than brightness of a reflected light obtained by reflection of the external light on the display surface.

5. The display apparatus according to claim 2, wherein if the brightness of the external light is constant, in a case where light-emitting brightness of the light-emitting member is low, the degree of suppression is higher than the degree of suppression in a case where the light-emitting brightness of the light-emitting member is high.

6. The display apparatus according to claim 1, further comprising at least one processor that operates as a light-emitting control unit configured to increase light-emitting brightness of the light-emitting member, so that display brightness of a dark portion of the second image data, the dark portion being adjacent to a light portion of the second image data, is not lower than brightness of a reflected light obtained by reflection of the external light on the display surface.

7. The display apparatus according to claim 6, wherein the light-emitting control unit increases the light-emitting brightness of the light-emitting member in a case where the display brightness of the dark portion does not reach the brightness of the reflected light even if the degree of suppression is increased.

8. The display apparatus according to claim 1, further comprising at least one processor that operates as a transmission control unit configured to increase transmittance of the second transmissive panel, so that display brightness of a dark portion of the second image data, the dark portion being adjacent to a light portion of the second image data, is not lower than brightness of a reflected light obtained by reflection of the external light on the display surface.

9. The display apparatus according to claim 8, wherein the transmission control unit increases the transmittance of the second transmissive panel in a case where the display brightness of the dark portion does not reach the brightness of the reflected light even if the degree of suppression is increased.

10. A display apparatus comprising:
a light-emitting member;
a transmissive panel configured to transmit a light emitted from the light-emitting member, based on image data; and
a detector configured to detect brightness of external light, wherein
in a case where the brightness of the external light is high, spatial high frequency components of the image data are less than the spatial high frequency components of the image data in a case where the brightness of the external light is low.

11. A control method of a display apparatus, wherein
the display apparatus includes:
a light-emitting member;
a first transmissive panel configured to transmit a light emitted from the light-emitting member; and
a second transmissive panel configured to display an image on a display surface by transmitting a light which is emitted from the light-emitting member and transmitted through the first transmissive panel,
the control method comprises:
a detection step of detecting brightness of external light; and
a transmission control step of executing control so that
the light emitted from the light-emitting member transmits through the first transmissive panel, based on first image data of which spatial high frequency components are less than spatial high frequency components of second image data, and
the light, which is emitted from the light-emitting member and transmitted through the first transmissive panel, transmits through the second transmissive panel based on the second image data, and
in a case where the brightness of the external light is high, the spatial high frequency components of the first image data are less than the spatial high frequency components of the first image data in a case where the brightness of the external light is low.

12. The control method according to claim 11, further comprising a generating step of generating the first image data by suppressing the spatial high frequency components of the second image data at a degree of suppression, wherein
in a case where the brightness of the external light is high, the degree of suppression is higher than the degree of suppression in a case where the brightness of the external light is low.

13. The control method according to claim 12, wherein
the processing to suppress the spatial high frequency components of the second image data is low-pass filter processing, and
in the generating step, the degree of suppression is changed by changing at least one of a size and a coefficient of a filter which is used for the low-pass filter processing.

14. The control method according to claim 12, wherein in the generating step, the degree of suppression is changed so that display brightness of a dark portion of the second image data, the dark portion being adjacent to a light portion of the second image data, is not lower than brightness of a reflected light obtained by reflection of the external light on the display surface.

15. The control method according to claim 12, wherein if the brightness of the external light is constant, in a case where light-emitting brightness of the light-emitting member is low, the degree of suppression is higher than the degree of suppression in a case where the light-emitting brightness of the light-emitting member is high.

16. The control method according to claim 11, further comprising a light-emitting control step of increasing light-emitting brightness of the light-emitting member, so that display brightness of a dark portion of the second image data, the dark portion being adjacent to a light portion of the second image data, is not lower than brightness of a reflected light obtained by reflection of the external light on the display surface.

17. The control method according to claim 16, wherein in the light-emitting control step, the light-emitting brightness of the light-emitting member is increased in a case where the display brightness of the dark portion does not reach the brightness of the reflected light even if the degree of suppression is increased.

18. The control method according to claim 11, wherein in the transmission control step, transmittance of the second transmissive panel is increased, so that display brightness of a dark portion of the second image data, the dark portion being adjacent to a light portion of the second image data, is not lower than brightness of a reflected light obtained by reflection of the external light on the display surface.

19. The control method according to claim 18, wherein in the transmission control step, the transmittance of the second transmissive panel is increased in a case where the display brightness of the dark portion does not reach the brightness of the reflected light even if the degree of suppression is increased.

20. A non-transitory computer readable medium that stores a program, wherein
the program causes a computer to execute a control method of a display apparatus,
the display apparatus includes:
a light-emitting member;
a first transmissive panel configured to transmit a light emitted from the light-emitting member; and
a second transmissive panel configured to display an image on a display surface by transmitting a light which is emitted from the light-emitting member and transmitted through the first transmissive panel,
the control method includes:
a detection step of detecting brightness of external light; and
a transmission control step of executing control so that
the light emitted from the light-emitting member transmits through the first transmissive panel, based on first image data of which spatial high frequency components are less than spatial high frequency components of second image data, and
the light, which is emitted from the light-emitting member and transmitted through the first transmissive panel, transmits through the second transmissive panel based on the second image data, and
in a case where the brightness of the external light is high, the spatial high frequency components of the first image data are less than the spatial high frequency components of the first image data in a case where the brightness of the external light is low.
